(19) United States
(12) Patent Application Publication
(10) Pub. No.: US 2006/0104732 A1
(43) Pub. Date: May 18, 2006

(54) Power Tool

(76) Inventor: Yao-Ju Huang, Taipei City (TW)

Correspondence Address: LEONG C LEI, PMB # 1008, 1867 YGNACIO VALLEY ROAD, WALNUT CREEK, CA, 94598, US

(21) Appl. No.: 10/986,366

(22) Filed: Nov. 12, 2004

(51) Int. Cl. B23B 45/00

(52) U.S. Cl. 408/124

(57) ABSTRACT

A power tool including a pistol grip handle containing a chamber connected to external opening to permit easy installation of batteries; a drive head provided at its end a rotation chuck to adapted to a bit of a hand tool, and multiple projection lights to project light to the bit; a control switch to control the on and off of the projection lights, a cover pivoted to the handle to cover up the opening; the cover swings on one side of the opening of the pistol grip handle; and multiple channels provided on the inner side of the cover for storage of bits.

### BACKGROUND OF THE INVENTION

(a) Technical Field of the Invention

The present invention is related to a power tool, and more particularly, to one that is portable, handy, consumes least space consuming, and permits operation in dark place.

(b) Description of the Prior Art

Power tools generally available in the market when working in dark place, additional lighting is required, making them somehow less convenient in the use. Furthermore, those power tools generally are adaptable to various types of bits of hand tools including screwdriver and drills, and those bits must be placed in a tool kit for easy access. However, bigger tool kit is required for those bits, thus to create problems of consuming larger space and not easy for the carry and use.

### SUMMARY OF THE INVENTION

The primary purpose of the present invention is to provide to a power tool that is portable, handy, consumes least space consuming, and permits operation in dark place. To achieve the purpose, the present invention includes a pistol grip handle containing a chamber connected through an external opening to facilitate installation of batteries; a drive head disposed on the top of the pistol grip handle having at its end provided with a rotation chuck to be adapted to a bit of a hand tool, and multiple projection lights to project the lights to the bit adapted; a control switch to control the on and off of those projection lights; and a cover having multiple channels disposed on its inner side to store bits pivoted to the pistol grip handle to cover up the opening and swing on one side of the opening of the pistol grip handle. Accordingly, those projection lights permit working in dark place and bits are stored in the cover without consuming extra space to allow easy carry and use of the power tool.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a preferred embodiment of the present invention.

FIG. 2 is a perspective view of the preferred embodiment of the present invention as assembled.

FIG. 3 is a schematic view showing that the preferred embodiment of the present invention is in use.

FIG. 4 is a sectional view of a local part of the preferred embodiment of the present invention in use.

FIG. 5 is a schematic view showing the preferred embodiment of the present invention in use with a cover opened.

FIG. 6 is a bird's eye view of a drive head of another preferred embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

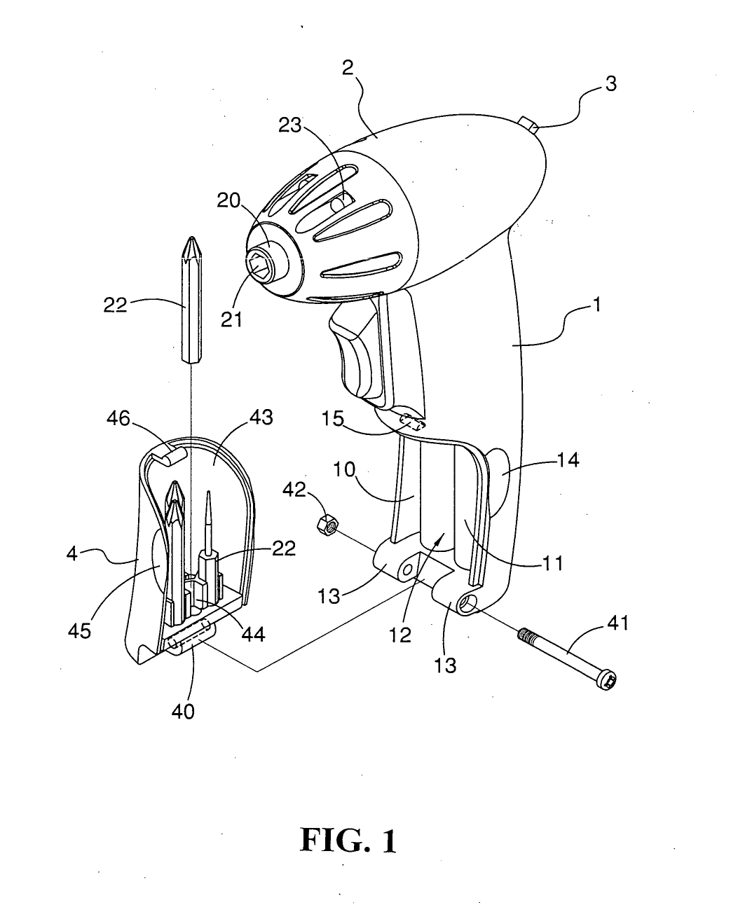

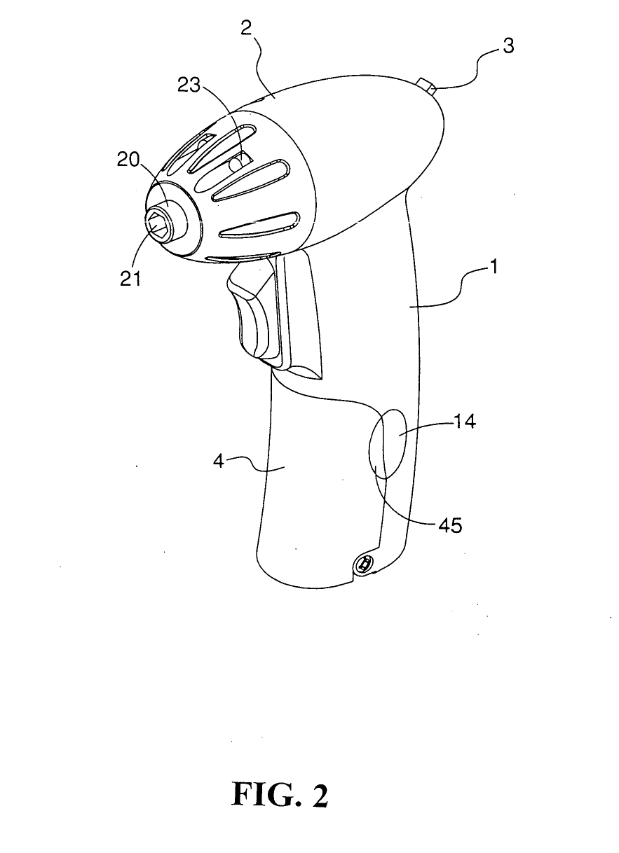

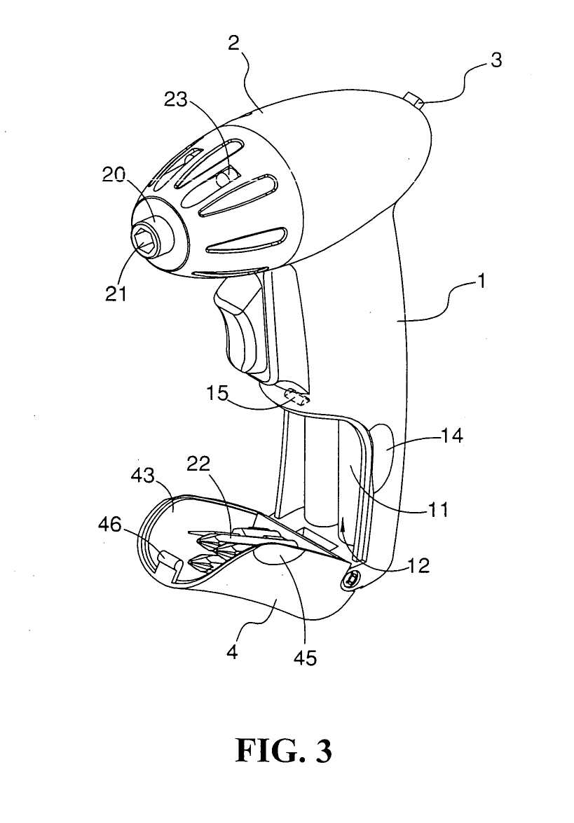

Referring to FIGS. 1 through 5 of the accompanying drawings, a preferred embodiment of the present invention is comprised of a pistol grip handle (1), a drive head (2), a control switch (3), and a cover (4). Wherein, the pistol grip handle (1) contains a chamber (10) for the installation of batteries (11). An opening (12) is provided on the front of the chamber (10) and connects through an opening (12) provided externally to the chamber (10) to facilitate installation of the batteries (11). Two ears (13) extend from both sides of the bottom edge of the opening (12). A first recess (14) is each provided on both sides of the opening (12), and a locking slot (15) is disposed on the pistol grip handle at where above the opening (12).

The driver head (2) is provided at the top of the pistol grip handle (1) for both of the driver head (2) and the pistol grip handle (1) to indicate a T shape. A chuck (20) allowing driven to rotate is provided at the front end of the drive head (2). An insertion hole (21) is provided to the chuck (20) to be adapted to a bit (22) from a hand tool. Multiple projection lights (23) are provided to the drive head (2). Each projection light (23) may be related to a light emitting diode (LED) to project its light to where the end of the bit (22) adapted to the chuck (20) operates.

The control switch (3) provided in the rear end of the drive head (2) to control on and off of those projection lights (23).

The cover (4) has at its bottom on the inner side provided with a protrusion (40) for the insertion into where between both ears (13) of the pistol grip handle (1) and penetrated through by an axial bolt (41) and a nut (42) for the cover (4) to cover up the opening (12) and to swing on one side of the opening (12) of the pistol grip handle (1). The interior of the cover (4) defines a trough (43) and multiple channels (44) are provided on the bottom of the trough (43) for storage of multiple bits (22). Furthermore, a second recess (45) is each provided on both sides of the cover (4) at where in relation to the first recess (14) on the pistol grip handle (1) to facilitate to open up the cover (4). A hook (46) extends from the top edge on the inner side of the cover (4) to clasp into the locking slot (15) of the pistol grip handle (1) to secure the cover (4) onto the opening (12).

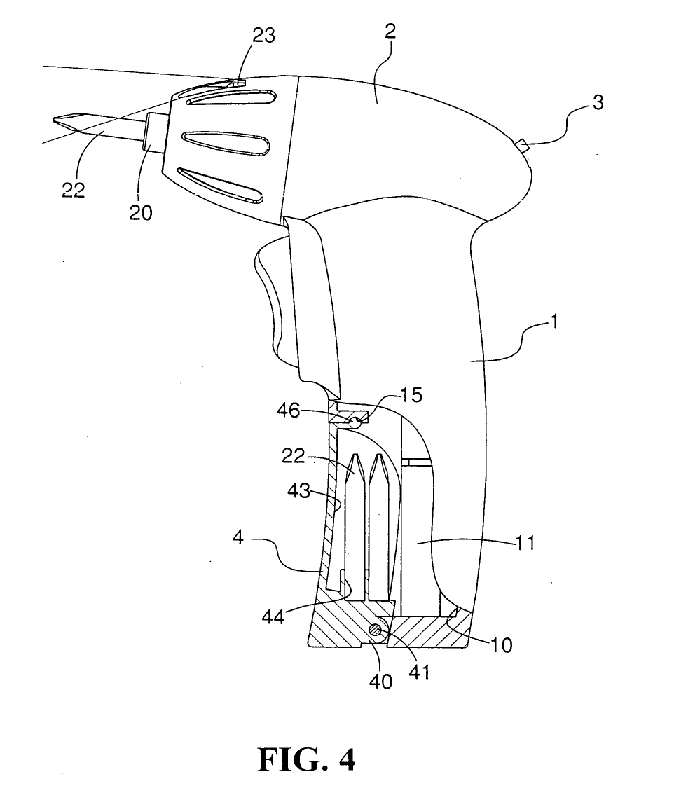

When the control switch (3) turns on the project light (23), the area where the bit (22) adapted to the chuck (20) is illuminated to facilitate the working in dark place as illustrated in FIG. 4.

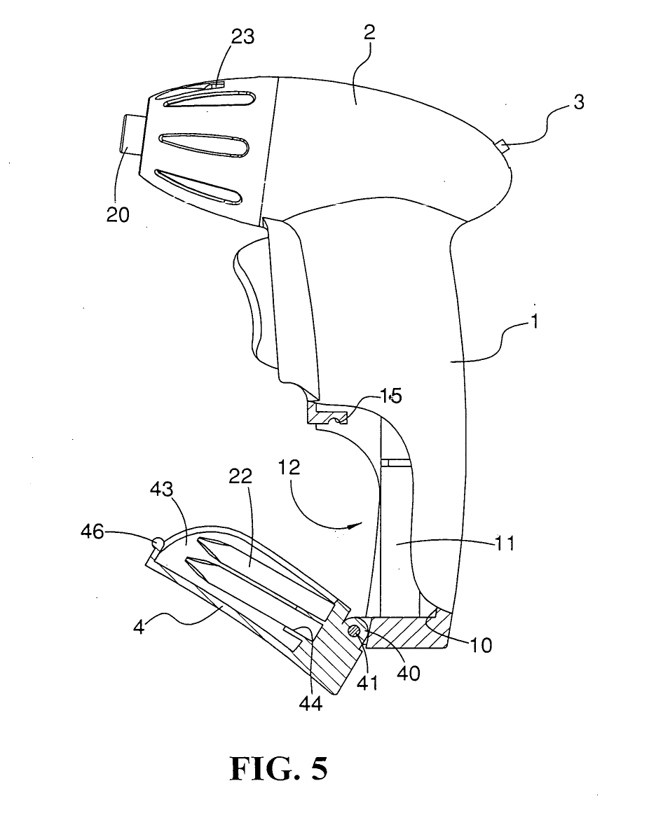

Now referring to FIG. 5, multiple bits (22) are stored in the cover (4). When the bit (22) is desired, simply open up the cover (4) to easily fetch the bit (22) to spare a separate tool kit for the storage of those bits (22), thus allowing easy use and portability of the present invention without consuming too much space.

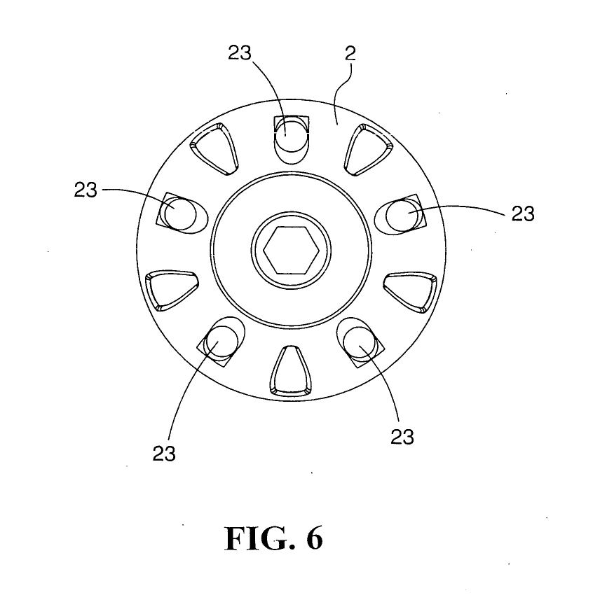

As illustrated in FIG. 6 for another preferred embodiment, five projection lights (23) arranged in a circle are provided on one end of the drive head (2).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-8. (canceled)

9. A power tool comprising:
a pistol grip handle containing a chamber; the chamber having an opening for installing at least one battery;
a drive head provided on a top of the pistol grip handle; a plurality of projection lights being disposed on the driver head; a chuck being extending from the drive head; a bit being installed in the chuck; the plurality of projection lights for projecting light to the bit;
a control switch for turning on and off of the projection lights; and
a cover pivoted to the pistol grip handle to cover upon the opening; the cover being openable at one side of the opening of the pistol grip handle, and a plurality of channels being provided on an inner side of the cover for storing a plurality of bits of different hand tools; and
two cars are formed at both sides of a bottom edge of the opening; a protrusion is provided at one side of the cover, and the protrusion is penetrated by an axial bolt and a nut so that the cover is swingable at one side of the opening of the pistol grip handle;
wherein a first recess is provided on both sides of the opening; a second recess is provided on both sides of the cover at a position corresponding to the first recess of the pistol grip handle; and
wherein the projection lights are light emitting diodes.

10. The power tool of claim 9, wherein a locking slot is provided on the upper section of the inner side of the opening; and a hook extends from a top edge on the inner side of the cover.

11. The power tool of claim 9, wherein five projection lights are arranged in a circle on the end of the drive head.
